(19) United States
(12) Patent Application Publication
(10) Pub. No.: US 2026/0222303 A1
(43) Pub. Date: Jul. 30, 2026

(54) NETWORK DIGITAL TWIN WITH AGENTIC MODEL AND KNOWLEDGE GRAPH

(71) Applicant: Dell Products L.P., Round Rock, TX (US)

(72) Inventors: Gwenael Poitau, Montreal (CA); Ibrahim Abu Alhaol, Nepean (CA); Javad Mirzaei, Toronto (CA); Rohit Arora, San Jose, CA (US); Said Tabet, Austin, TX (US)

(21) Appl. No.: 19/039,240

(22) Filed: Jan. 28, 2025

(51) Int. Cl. H04L 41/14; H04L 41/16; H04L 41/5009

(52) U.S. Cl. CPC H04L 41/145; H04L 41/16; H04L 41/5009

(57) ABSTRACT

A model-based network digital twin for forecasting and scenario generation is disclosed. The network digital twin includes twin components that each include a component model and a component knowledge graph. Each twin component is associated with a corresponding network component. Data from the network is ingested into the network digital twin and used to update the knowledge graphs. Requests received through an orchestration model are input to the component models, which generate responses using the corresponding component knowledge graphs. The orchestration model generates a final response to the request for an operator. The request may be a forecast or what-if scenario.

### TECHNOLOGICAL FIELD OF THE DISCLOSURE

Embodiments disclosed herein generally relate to network digital twins. More particularly, at least some embodiments relate to systems, hardware, software, computer-readable media, and methods for network digital twins configured with agentic models and knowledge graphs.

### BACKGROUND

A digital twin may be a computerized or virtual representation of a physical object or of a physical system. For example, a network, such as an open radio access network (O-RAN), can be modelled as a digital twin. A digital twin may also be used for testing, simulation, emulation, or other purposes. A network digital twin (NDT) may digitally implement the various components/applications/hardware/protocols of the physical network. The NDT may be configured to receive data from the network such that the network can be tested, simulated, or emulated in the NDT using real data.

Conventional NDTs continue to experience challenges in the context of modeling network components, which limits the usefulness of the NDTs. More specifically, conventional NDTs struggle to capture the complex inter-dependencies that exist among network components and struggle to adapt to rapidly or evolving states in the network. These limitations impact the fidelity of the digital twins and limit the ability of digital twins to generate accurate forecasts and generate diverse what-if scenarios.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a network such as an open radio access network (O-RAN);

FIG. 2 discloses aspects of a network digital twin (NDT) that includes component models and component knowledge graphs;

FIG. 3 discloses additional aspects of an NDT that is configure to generate forecasts and diverse what-if scenarios using component models and component knowledge graphs;

FIG. 4 discloses aspects of a method for generating forecasts and/or what-if scenarios in a digital twin; and

FIG. 5 discloses aspects of a computing device, a computing system, or a computing entity.

### DETAILED DESCRIPTION OF SOME EXAMPLE EMBODIMENTS

Embodiments disclosed herein generally relate to forecasting operations and scenario generation operations in a digital twin of a network. More particularly, at least some embodiments relate to systems, hardware, software, computer-readable media, and methods for modelling network operations or behavior in a network digital twin (NDT) that includes agentic models and knowledge graphs.

Embodiments of the invention are discussed in the context of open radio access networks (O-RANs), but may be implemented in other networks, including wireless networks, telecommunication networks, and other radio access networks (RANs).

Digital twins are digital or virtual representations of physical systems and NDTs may be used to represent these physical systems. Embodiments of the invention relate to a NDT discussed in the context of an O-RAN. In an O-RAN, a radio intelligent controller (RIC) may perform or manage various operations and tasks with various types of applications that may include rApps (non-real-time-applications), dApps (domain-specific applications) and xApps (near-real-time applications).

Generally, rApps may perform various operations or tasks such as managing policy, optimizing performance, and general network orchestration. Examples of rApps may include congestion forecasting, resource/power management, slicing operations, or the like. dApps are often employed in specific domains such as local or private networks, IoT (Internet of Things) operations, and the like. xApps may operate with higher proximity to the network and are configured to tasks or operations that include low-latency operations such as traffic steering, handover operations, or the like.

NDTs may rely on measurements or representations of radio frequency (RF) signals and key performance indicators (KPIs). KPIs can be categorized into various types including network KPIs (e.g., latency, throughput, connection density), quality of service KPIs (e.g., handover success rate, jitter, network availability), operational KPIs (e.g., resource efficiency/usage, interoperability, fault recovery), AI/ML (artificial intelligence/machine learning) metrics (e.g., accuracy, inference time). These KPIs may include other key performance indicators such as time stamps, velocity (e.g., user equipment speed, direction), signal strengths, latency, throughput, and the like.

In some examples, embodiments of the invention may incorporate, in addition to RF signal or RF related data, data modalities that may include, but are not limited to, sensor data, camera data (e.g., RGB data, depth images), two or three dimensional LiDAR (light detection and ranging) data, and the like.

Embodiments of the invention relate to an NDT configured to perform operations including, but not limited to, forecasting operations, what-if scenario operations, or the like. Embodiments of the invention relate to a digital twin configured to perform operations that rely on data that may include, by way of example only, RF data, KPIs, multi-modal data, and/or the like or combinations thereof. Embodiments of the invention advantageously reduce delays, account for interdependencies among and between components in the network, and are better configured to generate outputs (e.g., forecasts, what-if scenarios) with higher-fidelity.

In one example, the NDT represents components (e.g., a device, a sub-system) in the network using models (e.g., agentic foundation models, large language models) and knowledge graphs. Each network component is associated with a component knowledge graph and a component model. The NDT may also include an orchestration model that allows prompts to be generated and input to the NDT by an operator. The orchestration model, in response to the prompt, may query one or more of the components models. The component models, which may be agentic models, can generate a response to the original prompt.

In one example, the self-attention mechanism of models such as AFMs allows inter-dependencies among network components (e.g., inter-dependencies between/among hardware devices (e.g., radios, user equipment), software applications, controllers, or other components or portions of the network) to be captured during training and reflected in output of the NDT.

A component of a network may include a device or system (e.g., radio, server, tower, cell, an application, a set of devices/systems, a set of applications, a sub-network, or the like or combinations thereof. In other words, the component models in the NDT may be configured to model different components of portions of the network. The components to be modeled may be selected by a user, by default, or the like.

Using component models allows each component model to be fine-tuned or specialized for a specific component or portion of the network. This improves simulations, emulations, forecasts, what-if scenarios, and the like and results in more informed decision-making.

Embodiments of the invention relate to an NDT that ingests multi-modal data, which may include RF data and KPIs. This multi-modal data ensures that the NDT has an improved understanding and is able to better model the network at least because the state of the network is more accurate.

In some examples, the NDT may be implemented in a distributed manner. For example, component models may be distributed to edge locations to help optimize data movement, data storage, and compute requirements. Further, embodiments of the invention enable semantic information exchange in RICS and/or NDTS.

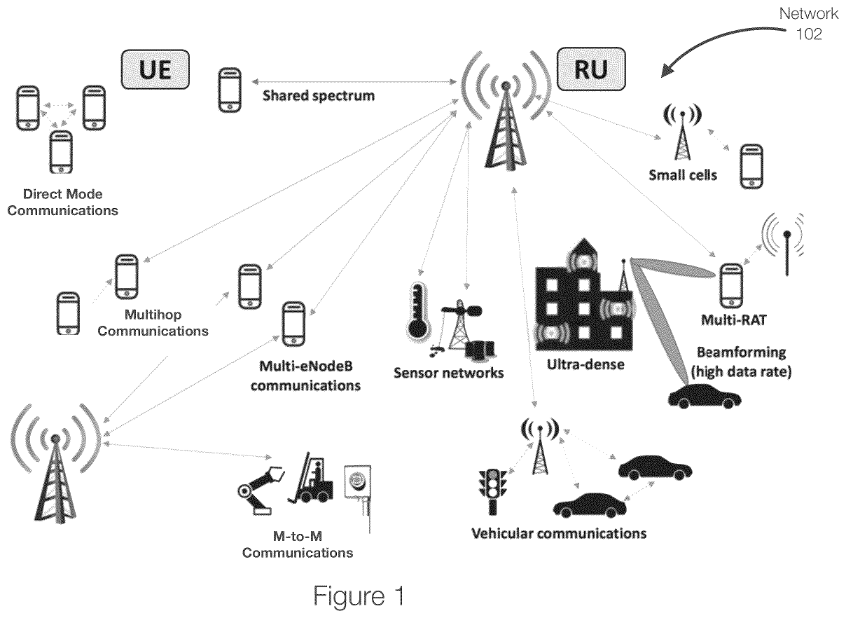

FIG. 1 discloses aspects of a network. FIG. 1 illustrates a network 102, which is an example of or which includes an example of an O-RAN or RAN. In this example, the network 102 includes towers, small cells, user equipment, multihop communications, multi-enodeB communications, sensor networks, vehicular communications, M-to-M communications, ultra-dense networks multi-RAT, beamforming, and the like. Each of these components may represent or include radio units (RU), distributed units (DU), and/or centralized units (CU).

Embodiments of the invention relate to performing forecasting generation and scenario generation in model-based NDTs as previously stated. In some examples, each of these units (RU, DU, CU) may be modeled with a corresponding component model in the NDT.

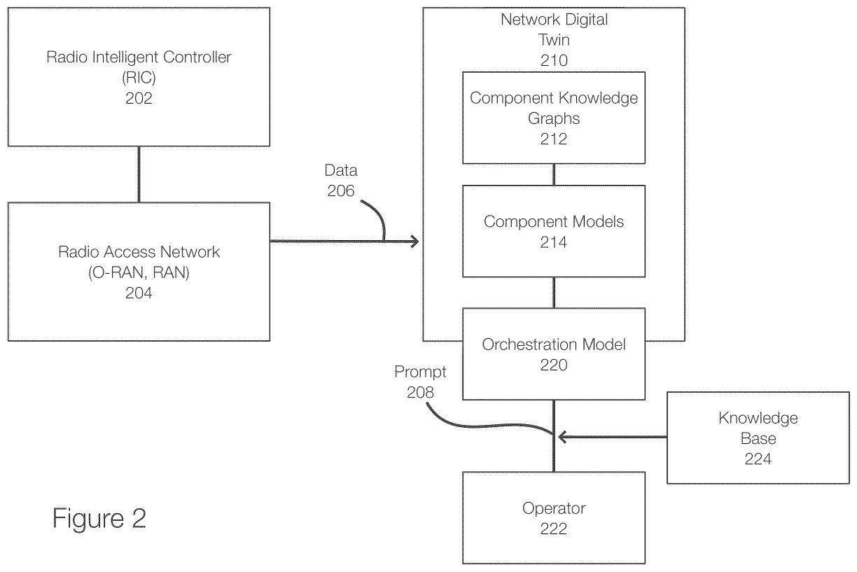

FIG. 2 discloses aspects of a digital twin configured for at least forecasting and/or what-if scenario related operations. More specifically, FIG. 2 illustrates a network 204, which is representative of networks including, but not limited to O-RANs, telecommunication networks, or the like. The network 204 is associated with an RIC 202. The RIC 202 is generally configured to control or manage the operation of the network 204. This may include, by way of example only, optimizing network performance, performing traffic control/steering, handover operations, power level control operations, or the like.

In this example, the network 204 is modeled by, represented by, and/or associated with a digital twin 210. The digital twin 210 may receive data 206 (or inputs) from the network 204 and/or the RIC 202. Examples of the data 106 may include, but are not limited to multi-modal data such as camera data (RGB data, depth data), LiDAR data, RF data, position (e.g., GPS or global positioning system) data, KPIs, sensor data, or the like or combinations thereof.

In one example, the data 206 may also include metadata of the components. For example, a radio may be associated with a maximum transmission power and the data 206 may include the actual transmission power of the radio. The data 206 is input to or provided the digital twin 210 and may be accessible to the component models 214.

The component models 214 may be associated with component knowledge graphs 212. The component models 214 may be large language models (LLMs), agentic foundation models (AFMs) or the like. In one example, the component models 214 and component knowledge graphs 212 are arranged or configured as pairs. More specifically, each of the component models 214 is associated with a different component knowledge graph such that each pair is associated with a component of the network 204.

In one example, the network 204 may be divided into components (e.g., radios, applications, layers, user devices) and each of these components may be associated with a corresponding pair of a component model and a knowledge graph. The component knowledge graphs 212 may include data about the corresponding component. For example, a component knowledge graph that corresponds to a radio may include or store information such as properties of the radio that may relate to the normal or expected operation of the radio. These properties may include recommended power transmitting range, operating frequency, modulation technique, antenna gain, bandwidth, maximum data rate, receiver sensitivity, and the like. In addition, the component models 214 may use the data 206 to add and/or update information to the component knowledge graphs 212. More specifically, the component knowledge graphs 212, in addition to storing metadata of the components that may be fixed or predetermined, may also store measured values, state, error signals, or the like. For instance, the knowledge graph of a radio may store both the maximum data rate at which data can be transmitted/received and the current data rate at which data is being transmitted/received. The knowledge graph of a radio may store both the maximum number of connections and the current number of active connections. The component models 214 are configured to receive the data 206 and update the component knowledge graphs 212. The NDT 210 may distribute data for the component knowledge graphs 212 as needed.

The NDT 210 may also be associated with or include an orchestration model 220. The orchestration model 220, which may be an LLM or AFM in one example, is configured to receive a prompt 208 from an operator 222. The prompt 208 may be augmented with context (e.g., a knowledge base 224 may be consulted and sources may be retrieved from the knowledge base 224 based on the input from the operator 222. The operator 222 may be an automated agent or a human-in-the-loop in some examples. The orchestration model 220 may be an LLM or an AFM and may receive the prompt 208 semantically. The orchestration model 220 is configured to generate prompts as necessary for the component models 214. The component models prompted in this manner may query their respective component knowledge graph and generate a response. The component models 214 may be configured to communicate with each other. The response or responses received by the orchestration model 220 from the component models 214 may be combined by the orchestration model 220 and provided as a response to the operator 222.

In some examples, the component models 214 and/or the orchestration model 220 are trained on historical data, logs, component configurations, standards, and the like. The component models 214 may be fine-tuned based on data from corresponding network components. This helps ensure that the component models 214 and the orchestration model 220 account for component interdependencies, which improves the fidelity of the network digital twin 210.

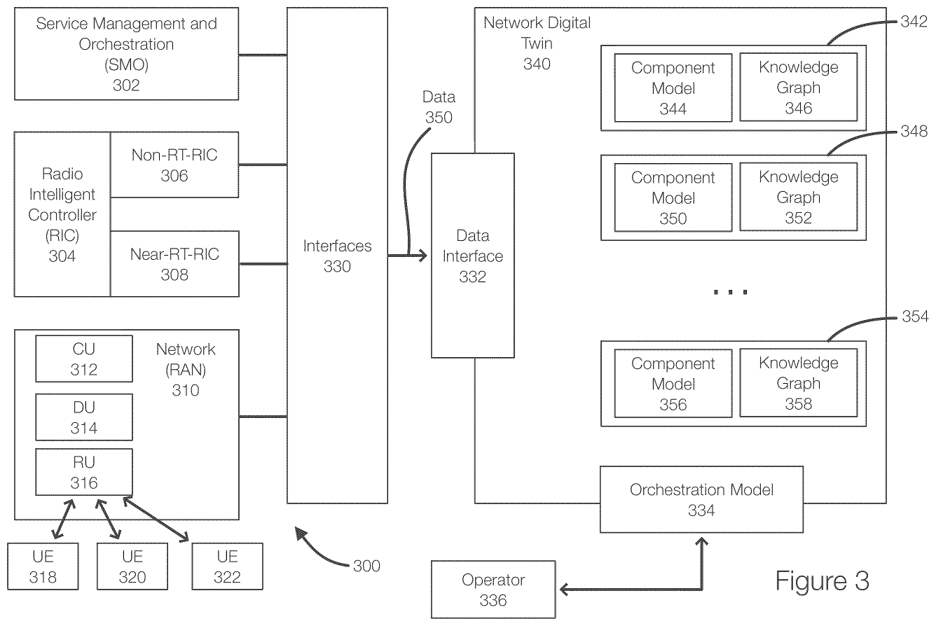

FIG. 3 discloses additional aspects of a network digital twin configured at least for forecasting and scenario analysis. In this example, an example system 300 may include a network 310, such as a RAN, a radio intelligent controller (RIC) 304 of the network 310, and a Service Management and Orchestration (SMO) 302. The RIC 304 is represented or includes, in this example, a non-real time RIC 306 and a near-real time RIC 308. The RIC 306 may be configured to perform functions and operations that may not be time critical. For example, the RIC 306 may be configured to perform policy management, network optimization and the like. The RIC 308 may be configured to handle tasks that are more time critical such as steering traffic, resource management, and the like. The SMO 302 is an example of a system orchestrator that may manage deployments, configurations, scaling, and the like. The system 300 also includes interfaces 330 (e.g., O-RAN interfaces).

The network 310 may include a central unit (CU) 312, distributed units (DU) 314, and radio units (RU) 316. The RU 316 may handle or perform radio frequency (RF) processing (e.g., physical layer). The DU 314 may perform higher layer processing in the network 310. The network 310 may include or service user equipment (UE), represented by UE 318, 320, and 322. The CU 312 may represent a portion of the network 310 that connects the network 310 to other networks such as mobile networks, the internet, and the like.

In this example, the system 300 is divided into components such as the SMO 302, the RIC 304, the RIC 306, the RIC 308, the CU 312, the DU 314, the RU 316, and the UE 318. Each of the components, which may include a single device/system, multiple devices/systems, or the like, has a corresponding twin component in the NDT 340. The twin components 342, 348, and 354 represent the corresponding network components.

For example, the twin component 342 may represent the SMO 302. The twin component 342 includes a component model 344 and a knowledge graph 346. The twin component 348 may represent the RIC 306 and include a component model 350 and a knowledge graph 352. The twin component 354 may represent the RU 314 and include a component model 356 and a knowledge graph 358.

By way of example, assuming that the twin component 354 corresponds to the RU 316, the component model 356 may be trained using data of the network and fine-tuned using data specific to the RU 316. This allows inter-dependencies to be captured in the component model 356. The knowledge graph 358 corresponds to the RU 316 and includes information or metadata, in graph form in this example, of the RU 316. The knowledge graph 358 may include characteristics or properties of the RU such as maximum transmission power, maximum connections, version, capabilities, settings, or the like. During operation, multi-model data of the RU 316 (e.g., KPIs) may be used to update the knowledge graph 358 with data such as current transmission power, current number of active connections, active connections to other network components, and the like. Thus, the multi-modal data of the network 310 or of the system 300 is delivered to the network digital twin 340 via the interfaces 330 and the data interface 332. Data relevant to the component model 356 is received by the twin component 354 and incorporated into the knowledge graph 358.

FIG. 3 illustrates that the NDT 340 is thus configured to update the knowledge graphs 346, 352, and 358 continually or as new data is received. This helps ensure that the knowledge graphs 346, 352, and 358 represent a current state of the corresponding network components.

The component models 344, 350, 356 are also configured to communicate with each other. For example, the component models of two radios in communication may communicate data related to the current communication. In a what-if scenario that requires two radios to communicate, the corresponding component models may share information. In addition or alternatively, responses from the component models 344, 350, and 356 may be evaluated and combined by the orchestration model 334.

In one example, the orchestration model 334 may be trained with data including logs, standards, historical multi-modal data (both normal and non-normal or incident related data). This allows the orchestration model 334 to combine the responses of the component models in a meaningful manner and generate a more accurate response to the operator 336.

For example, the operator 36 may generate a query of what would happen if the number of users in cell x were increased. The orchestration model 334 may distributed this query to the component models (or selected component models including component models associated with the cell x). The component models can query the corresponding knowledge graphs and generate responses. For example, the component models may determine that the number of users in the cell x is currently at a maximum and that increasing the number of users would likely case a failure or a decrease in the quality of service. The component model of a neighboring cell may indicate that the number of users for that cell is low and that traffic can be rerouted as necessary to that cell. This information, when receive by the orchestration model 334 may allow a response or recommendation to be generated that, if implemented, adds users to the cell x in part by rerouting some of the current traffic or users to the neighboring cell or to a different radio.

Thus, the component models 344, 350, and 356 are trained and account for inter-dependencies in the system 300. Because the knowledge graphs 346, 352, and 358 represent the components of the system 300, an operator 336 may provide prompts that relate to forecasting and what-if scenarios.

The network digital twin 340 thus includes multiple agentic models that can be specialized for specific components, thereby allowing multiple network components to be comprehensively represented. This results in more comprehensive simulations, forecasts, and the like.

The knowledge graphs provide a foundation for understanding the operations of the network and enable contextual awareness of the complex inter-dependencies in the network 310. The fidelity of forecasting is improved. For example, the future states of network components can be forecasted based on the data 350 received by the twin components, which is incorporated into the knowledge graphs of the NDT 340.

Because the component models 344, 350, and 356 and the orchestration model 334 have generative capabilities, realistic scenarios can be generated and input into the network digital twin 340. This allows stress testing, planning, and optimization operations to be performed by using the NDT 340 for what-if analysis.

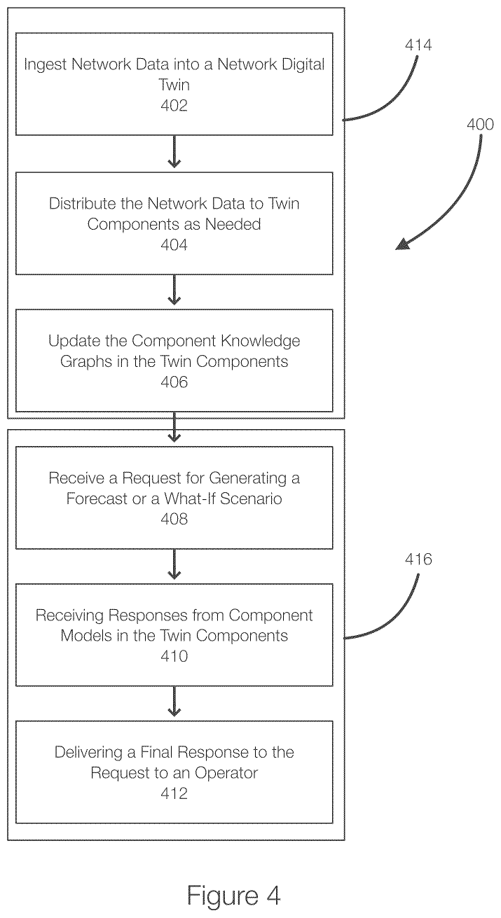

FIG. 4 discloses aspects of a method for generating forecast and/or what-if scenarios in a digital twin. The method 400 may include ingesting 402 data received from a network (e.g., an O-RAN). The data may include multi-modal data, component data, or the like. Because the network digital twin includes twin components, each including a component model and a component knowledge graph, the data received from the network is distributed 404 as needed to the twin components and the component knowledge graphs are updated 406 using the data. For example, a twin component corresponding to a specific radio may receive data associated with that specific radio (e.g., current transmitting power, number of connected users, bandwidth consumption).

The method 400 may include portions that may occur sequentially and/or in parallel. For example, the method 414 relates in particular to updating the knowledge graphs. The method 416 more generally relates to servicing requests received by the network digital twin.

In this example, the method 416 may include receiving 408 a request at an orchestration model. The request may be to generate a forecast or a what-if scenario. The request is provided to the component models, which access the corresponding component knowledge graphs to generate responses, which are received 410 by the orchestration model.

The orchestration model then delivers 412 a final response to the request to the operator. The final response may be generated of synthesized from the responses received from the component models.

The final response may be considered and changes that may be recommended in the final response may be implemented, delayed, discarded, or the like. Decisions related to the network may be made based on the outcome of a what-if scenario or a forecast. In some examples, because network states and conditions change frequently, changes in the network may be delayed until certain conditions are satisfied, the request may be repeated at a later time, or the like.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, network digital twin operations, forecasting operations, what-if generation related operations, multi-agent operations, knowledge graph operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects. Further, the AFMs may be trained with historical and/or synthetic data.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: ingesting data of a network at a network digital twin via a data interface, wherein the data includes key performance indicators, distributing the data to twin components in the network digital twin, wherein each of the twin components includes a component model and a component knowledge graph, wherein each of the twin components is configured to model a corresponding network component, updating the component knowledge graphs in the twin components based on the data, receiving a request at an orchestration model included in or associated with the network digital twin, wherein the orchestration model executes the request using the twin components, receiving responses to the request from the twin components, and delivering, by the orchestration model, a final response to the request to the operators, wherein the final response is generated from the responses received from the twin components.

Embodiment 2. The method of embodiment 1, wherein the data ingested from the network includes multi-modal data including one or more device state data, device operative values, global positioning system data, sensor data, camera data, image data, distance data, or combinations thereof.

Embodiment 3. The method of embodiment 1 and/or 2, wherein the network includes one or more of an open radio access network, a telecommunications network, or a radio access network.

Embodiment 4. The method of embodiment 1, 2, and/or 3, wherein the component models are fine-tuned for the corresponding network components based on at least training data related to the corresponding network components.

Embodiment 5. The method of embodiment 1, 2, 3, and/or 4, wherein each of the component models updates its corresponding component knowledge graph based on relevant data included in the data.

Embodiment 6. The method of embodiment 1, 2, 3, 4, and/or 5, wherein the orchestration model prompts the component models and the responses are based on information retrieved from corresponding component knowledge graphs.

Embodiment 7. The method of embodiment 1, 2, 3, 4, 5, and/or 6, wherein the component models are trained using historical data and are aware of inter-dependencies that exist in the network, and herein the orchestration model is trained on historical data including logs, standards, normal network data, incident network data.

Embodiment 8. The method of embodiment 1, 2, 3, 4, 5, 6, and/or 7, wherein the request comprises a forecasting request and the response is a forecast.

Embodiment 9. The method of embodiment 1, 2, 3, 4, 5, 6, 7, and/or 8, wherein the request comprises a what-if scenario and the response is a potential outcome of the scenario.

Embodiment 10. A method comprising: receiving a request at an orchestration model included in or associated with a network digital twin, wherein the request is for a forecast or a what-if scenario, wherein the orchestration model executes the request using twin components of the network digital twin, wherein each of the twin components corresponds to a network component of a network and wherein each of the twin components includes a component model and a component knowledge graph that correspond to the network component, prompting the component models based on the request, receiving responses to the request from the component models of the twin components, and delivering, by the orchestration model, a final response to the request to the operators, wherein the final response is generated from the responses received from the twin components.

Embodiment 11. The method of embodiment 10, wherein the operator is an agent and is configured to generate what-if scenarios to input to the network digital twin, wherein the final response is a forecast or a scenario result.

Embodiment 12. A system, comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

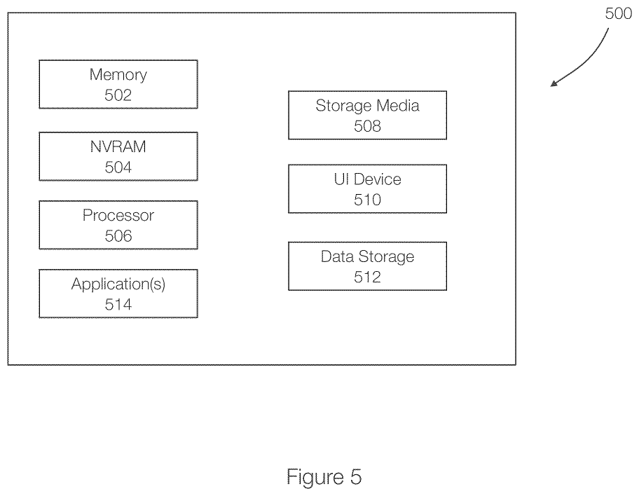

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

The device 500 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may also represent a physical or virtual machine or server, an edge-based computing system, a cloud-based computing system, server clusters or other computing systems or environments. The device 500 may also represent multiple machines or devices, whether virtual, containerized, or physical. The device 500 may perform or execute steps or acts of the methods illustrated in the Figures.

The device 500 may represent a cloud-based system, an edge-based, system, an on-premise system, or combinations thereof. The device 500 may be a computing system that is distributed geographically. For example, a network digital twin may include twin components implemented in a plurality of distributed devices 500.

In one example, the RIC and/or network digital twin may be integrated with the network, may be implemented using servers, clusters, or the like. The RIC and/or network digital twin may include distributed components. Data input to the models of the network digital twin may be sourced from multiple locations and multiple models and/or digital twins may be used in parallel.

The described embodiments are to be considered in all respects only as illustrative and not restrictive. All changes which come within the meaning and range of equivalency of the claims are to be embraced within their scope.

What is claimed is:

1. A method comprising:
ingesting data of a network at a network digital twin via a data interface, wherein the data includes key performance indicators;
distributing the data to twin components in the network digital twin, wherein each of the twin components includes a component model and a component knowledge graph, wherein each of the twin components is configured to model a corresponding network component;
updating the component knowledge graphs in the twin components based on the data;
receiving a request at an orchestration model included in or associated with the network digital twin, wherein the orchestration model executes the request using the twin components;
receiving responses to the request from the twin components; and
delivering, by the orchestration model, a final response to the request to the operators, wherein the final response is generated from the responses received from the twin components.

2. The method of claim 1, wherein the data ingested from the network includes multi-modal data including one or more device state data, device operative values, global positioning system data, sensor data, camera data, image data, distance data, or combinations thereof.

3. The method of claim 1, wherein the network includes one or more of an open radio access network, a telecommunications network, or a radio access network.

4. The method of claim 1, wherein the component models are fine-tuned for the corresponding network components based on at least training data related to the corresponding network components.

5. The method of claim 1, wherein each of the component models updates its corresponding component knowledge graph based on relevant data included in the data.

6. The method of claim 1, wherein the orchestration model prompts the component models and the responses are based on information retrieved from corresponding component knowledge graphs.

7. The method of claim 1, wherein the component models are trained using historical data and are aware of inter-dependencies that exist in the network, and wherein the orchestration model is trained on historical data including logs, standards, normal network data, incident network data.

8. The method of claim 1, wherein the request comprises a forecasting request and the response is a forecast.

9. The method of claim 1, wherein the request comprises a what-if scenario and the response is a potential outcome of the scenario.

10. A non-transitory storage medium having stored therein instructions that are executable by one or more hardware processors to perform operations comprising:
ingesting data of a network at a network digital twin via a data interface, wherein the data includes key performance indicators;
distributing the data to twin components in the network digital twin, wherein each of the twin components includes a component model and a component knowledge graph, wherein each of the twin components is configured to model a corresponding network component;
updating the component knowledge graphs in the twin components based on the data;
receiving a request at an orchestration model included in or associated with the network digital twin, wherein the orchestration model executes the request using the twin components;
receiving responses to the request from the twin components; and
delivering, by the orchestration model, a final response to the request to the operators, wherein the final response is generated from the responses received from the twin components.

11. The non-transitory storage medium of claim 10, wherein the data ingested from the network includes multi-modal data including one or more device state data, device operative values, global positioning system data, sensor data, camera data, image data, distance data, or combinations thereof.

12. The non-transitory storage medium of claim 10, wherein the network includes one or more of an open radio access network, a telecommunications network, or a radio access network.

13. The non-transitory storage medium of claim 10, wherein the component models are fine-tuned for the corresponding network components based on at least training data related to the corresponding network components.

14. The non-transitory storage medium of claim 10, wherein each of the component models updates its corresponding component knowledge graph based on relevant data included in the data.

15. The non-transitory storage medium of claim 10, wherein the orchestration model prompts the component models and the responses are based on information retrieved from corresponding component knowledge graphs.

16. The non-transitory storage medium of claim 10, wherein the component models are trained using historical data and are aware of inter-dependencies that exist in the network, and herein the orchestration model is trained on historical data including logs, standards, normal network data, incident network data.

17. The method of claim 10, wherein the request comprises a forecasting request and the response is a forecast.

18. The method of claim 10, wherein the request comprises a what-if scenario and the response is a potential outcome of the scenario.

19. A method comprising:
receiving a request at an orchestration model included in or associated with a network digital twin, wherein the request is for a forecast or a what-if scenario, wherein the orchestration model executes the request using twin components of the network digital twin, wherein each of the twin components corresponds to a network component of a network and wherein each of the twin components includes a component model and a component knowledge graph that correspond to the network component;
prompting the component models based on the request;
receiving responses to the request from the component models of the twin components; and
delivering, by the orchestration model, a final response to the request to the operators, wherein the final response is generated from the responses received from the twin components.

20. The method of claim 19, wherein the operator is an agent and is configured to generate what-if scenarios to input to the network digital twin, wherein the final response is a forecast or a scenario result.
